(19) United States
(12) Patent Application Publication
(10) Pub. No.: US 2006/0217645 A1
(43) Pub. Date: Sep. 28, 2006

(54) Massage system and methods for massaging a patient

(76) Inventor: Thomas Lockamy, Charlotte, NC (US)

Correspondence Address: TRASK BRITT, P.O. BOX 2550, SALT LAKE CITY, UT, 84110, US

(21) Appl. No.: 11/373,824

(22) Filed: Mar. 9, 2006

Related U.S. Application Data
(60) Provisional application No. 60/660,005, filed on Mar. 9, 2005.

(51) Int. Cl. A61H 7/00

(52) U.S. Cl. 601/148; 601/150

(57) ABSTRACT

A massage system that may be incorporated with a dental chair or which may be retrofit to a dental chair to provide massaging motions to a patient positioned in the dental chair.

### CROSS-REFERENCE TO RELATED APPLICATIONS

This application claims the benefit of U.S. Provisional Application No. 60/660,005, filed Mar. 9, 2005, entitled “MASSAGING DENTAL CHAIR” and incorporates the same herein by reference in its entirety.

### BACKGROUND OF THE INVENTION

1. Field of the Invention

The present invention relates to massage systems and more particularly to massage systems integrated with dental chairs and kits for retrofitting dental chairs or other support devices with massage systems.

2. State of the Art

In our society, many patients attending dental offices for dental procedures exhibit at least some amount of increased anxiety upon visiting the dentist. Although no logical reason for such increased levels of anxiety may exist, such anxiety is often unwanted. Other than reassurances from the dentist, the dentist's staff, and others offering encouragement, such anxiety is difficult to decrease. In some instances, the increased anxiety levels experienced by a patient in a dentist's office may also increase the blood pressure of the patient.

Visits to a dentist's office may also be uncomfortable. This may be especially true when long procedures on a patient are necessary, requiring the patient to lie still in a prone position for extended periods of time. Remaining in such a prone position for extended periods may decrease blood flow to certain areas of the body which may be undesirable medically.

Massage therapy may be used to decrease anxiety. Massage systems, such as those described in U.S. Pat. No. 6,916,300 entitled “SEAT MASSAGER,” assigned to Bowles Fluidics Corporation, and issued on Jul. 12, 2005, which is incorporated herein by reference in its entirety, have been adapted for use with chairs such as Lay-Z-Boy® recliners and others.

Therefore, it is desirable to adapt a dental chair to decrease anxiety in a patient positioned in the dental chair.

### BRIEF SUMMARY OF THE INVENTION

According to embodiments of the invention, a massage system may be incorporated with an apparatus and in particular a support surface of an apparatus. The massage system may include one or more bladders that may be inflated and deflated to cause movement of the support surface in association with the bladders. The bladders may be inflated and deflated with a gas or a fluid. The inflation and deflation of the bladders may be controlled by an operator or by a person positioned on the support surface.

According to other embodiments of the invention, a massage system may be incorporated with a dental chair. The massage system may include one or more inflatable and deflatable bladders incorporated within the dental chair to provide one or more massaging movements to the support surfaces of the dental chair. The massage system may be removably connected to the dental chair and may utilize an air supply source incorporated with the dental chair to inflate and deflate the bladders.

In some embodiments of the invention, a massage system kit may be retrofit to a conventional chair, dental chair, or other apparatus providing a support structure. For example, a conventional dental chair having a back support and a seat and leg support may be retrofit with a massage system kit having a regulator bracket for regulating the pressure of air introduced to the massage system, a switch box for controlling the on and off features of the massage system, and one or more valves and one or more bladders in communication with the valves for providing air entering the regulator bracket and switchbox to the one or more bladders. The inflation and deflation of the one or more bladders may provide motion to a support surface connected to the one or more bladders.

In other embodiments of the invention a dental chair is provided, the dental chair including a back support, a seat and leg support, at least one massage system incorporated with the back support, at least one valve for regulating air flow to the massage system, and at least one supply source for providing air or another fluid to the at least one valve.

In still other embodiments of the invention, methods for massaging a patient in a chair are provided. A dental chair may be provided wherein the dental chair includes at least one bladder associated with a support surface thereof and a supply source for providing the at least one bladder with a fluid or gas to inflate or deflate the at least one bladder. A fluid or gas is provided from the supply source to the at least one bladder, thereby inflating the at least one bladder. The at least one bladder may then be allowed to deflate. The inflating and deflating may be repeated, thereby providing movement to the support surface associated with the at least one bladder, the movement providing a massaging motion to a patient or occupant of the chair, such as a dental chair.

### BRIEF DESCRIPTION OF THE SEVERAL VIEWS OF THE DRAWINGS

While the specification concludes with claims particularly pointing out and distinctly claiming that which is regarded as the present invention, this invention can be more readily understood and appreciated by one of ordinary skill in the art from the following description of the invention when read in conjunction with the accompanying drawings in which:

FIG. 1 illustrates a massage system according to an embodiment of the invention;

FIG. 2 illustrates a massage system according to an embodiment of the invention;

FIG. 3 illustrates a dental chair incorporating particular embodiments of the invention; and

FIG. 4 illustrates a schematic flow diagram of various components of a massage system according to particular embodiments of the invention.

### DETAILED DESCRIPTION OF THE INVENTION

According to an embodiment of the invention, a massage system may be incorporated with one or more support surfaces of an apparatus. The massage system may provide oscillations, vibrations, or other movement to the one or more support surfaces of the apparatus.

In some particular embodiments of the invention, a massage system may be incorporated into a chair, such as a dental chair, to provide a patient or a subject positioned on the chair with a massage. The massage system may be controlled such that the massage may be tailored to the patient, controlled by the patient, or controlled by an operator of a chair incorporating the massage system.

In other embodiments of the invention, the massage system may be incorporated into various parts for a chair, such as a dental chair, such that the chair parts incorporating the massage system, or portions of the massage system, may be used to retrofit a chair with at least one or more parts of a massage system according to embodiments of the invention.

According to still other embodiments of the invention, a massage system kit may be provided such that the massage system may be incorporated with a support surface of an apparatus, such as with various support surfaces provided by a chair, and in particular, dental chairs.

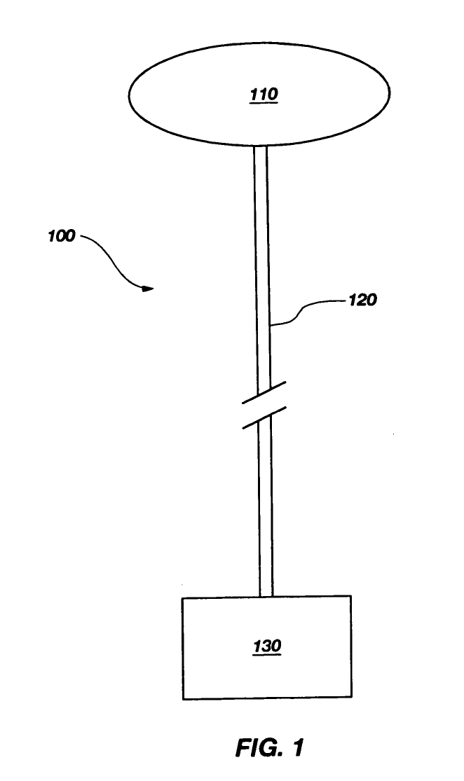

A massage system 100 according to particular embodiments of the invention may include an inflatable and deflatable bladder 110, as illustrated in FIG. 1. The bladder 110 may be inflated with a fluid, such as water, or a gas, such as air. A delivery line 120 in communication with the bladder 110 may provide a fluid or gas to the bladder 110 to inflate the bladder 110 with the delivered fluid or gas. A fluid or gas may be delivered to a bladder 110 from a supply source 130, which may provide a supply of gas or fluid. The supply source 130 may also incorporate one or more pumps, actuators, or other devices to deliver fluid or gas from the supply source 130, through the delivery line 120 to a bladder 110.

A bladder release (not shown) for deflating the bladder 110 may be incorporated with the bladder 110. For example, the bladder release may include a valve that releases a fluid or gas from the bladder 110 when the bladder 110 reaches a certain pressure. The bladder release may also be incorporated with the delivery line 120 such that the bladder release allows the delivery line 120 to supply a fluid or gas to the bladder 110 until a preset upper-limit pressure is achieved in the bladder 110, at which time the bladder release stops the flow of a gas or fluid to the bladder 120 and begins to release the fluid or gas in the bladder 110 until a lower-limit pressure is reached in the bladder. When the lower-limit pressure is achieved, the bladder release may stop the release of fluid or gas from the bladder and again permit flow of fluid or gas from the delivery line 120 into the bladder 110.

The embodiment of the massage system 100 illustrated in FIG. 1 may be incorporated with a support surface, such that the inflation and deflation of the bladder 110 provides movement to the support surface. For example, a massage system 100 may be incorporated with the back-rest portion of a dental chair such that the massage system 100 provides movement to the support surface of the back-rest portion of the dental chair. The movement provided by the massage system 100 to the support surface may be a type of movement that provides a massage to an occupant positioned against the support surface. For instance, the movement may include pulsating, oscillating, or other movements which are pleasing to a person supported by the support surface.

In those embodiments of the invention where a massage system is incorporated with a dental chair, the supply source 130 may include an air source provided to the dental chair. For example, many dental chairs are equipped with an air supply to the dental chair. The air supply typically delivers air to the dental chair such that dental instruments may be connected to the dental chair and powered by the air supply. For instance, air supplies providing 80 to 100 psi air pressure may be connected to a dental chair, the air supplies being capable of driving dental instruments such as drills or providing air streams for use in dental procedures. An air supply to a dental chair may be attached to, or act as a supply source 130 for, the massage system 100. In some embodiments, the supply source 130 may be a regulator capable of regulating the amount of pressure supplied to the bladder 110 by the air supplied to the dental chair.

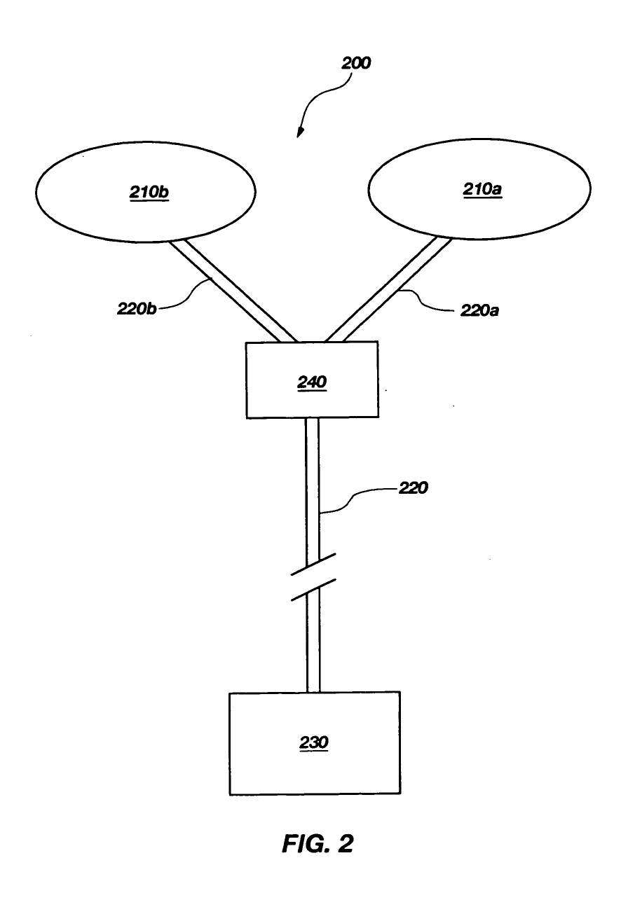

In other embodiments of the invention, a massage system 200 may include one or more bladders 210 as illustrated in FIG. 2. Although only two bladders 210a and 210b are illustrated in FIG. 2, it is understood that additional bladders 210 may be incorporated with massage systems 200 according to particular embodiments of the invention. The one or more bladders 210 may be connected to a valve 240 capable of regulating the flow of fluids or gases from one or more supply sources 230 to the bladders 210. Fluids or gases may be delivered to the valve 240 through one or more delivery lines 220 and from the valve 240 to one or more bladders 210 through bladder-delivery lines 220a and 220b.

The valve 240 may regulate flow of fluid or gas delivered from one or more supply sources 230 to a first bladder 210a or a second bladder 210b. According to some embodiments of the invention, the valve 240 may regulate the flow of a fluid or gas to the first bladder 210a until the pressure in the first bladder 210a reaches an upper-limit pressure, at which point the valve 240 allows the fluid or gas from the first bladder 210a to bleed off and will begin filling the second bladder 210b with a fluid or gas until a second upper-limit pressure is reached in the second bladder 210b. The valve 240 may then switch back to the filling of the first bladder 210a. In this manner, the first bladder 210a and the second bladder 210b may be alternately at least partially inflated and at least partially deflated. The alteration of the inflation and the deflation of the first bladder 210a and the second bladder 210b may cause the movement of a support surface in communication with the bladders 210 such that the movement provides a massaging movement to a person in contact with the support surface.

The massage system 200 illustrated in FIG. 2 may be incorporated with a support surface such that inflation and deflation of the bladders 210 provides movement to the support surface. For example, a massage system 200 may be incorporated with the back-rest portion of a dental chair such that the massage system 200 provides movement to the support surface of the back-rest portion of the dental chair. The movement provided by the massage system 200 to the support surface may be a type of movement that provides a massage to an occupant positioned against the support surface. For instance, the movement may include pulsating, oscillating, or other movements which are soothing to a person supported by the support surface.

In still other embodiments of the invention, multiple massage systems may be incorporated into an apparatus, such as a dental chair. For example, a first massage system may be incorporated into a back-rest portion of a dental chair to provide massaging motions to the shoulder areas of the back-rest portion of the dental chair. A second massage system may be incorporated into the same back-rest portion of the dental chair to provide massaging motions to a lumbar support region of the back-rest portion of the dental chair. A third massage system may be incorporated with a seat portion of the dental chair to provide massaging motion to the seat area of the dental chair. Additional massage systems could also be incorporated to provide massaging motion to other areas of the dental chair, such as to the leg portions of a dental chair or the arm portions of a dental chair.

Furthermore, a single massage system having a plurality of bladders may be incorporated with a dental chair such that multiple areas of a patient's body may be massaged while the patient is positioned in the dental chair. For instance, the massage system may massage the shoulders of the patient, the lumbar region of the patient, one or more legs of the patient, and the arms of the patient.

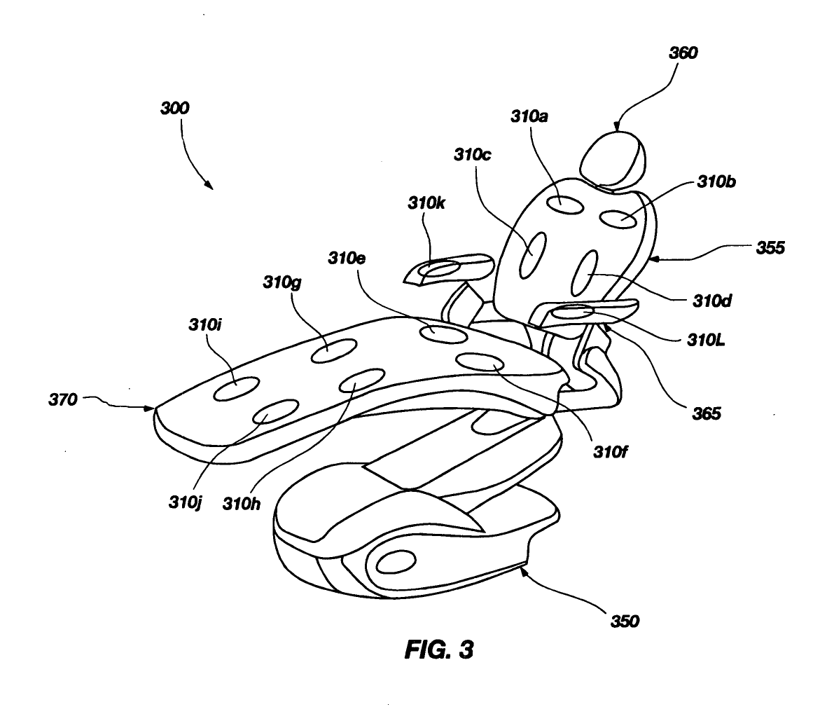

A dental chair incorporating multiple massage systems according to embodiments of the invention is illustrated in FIG. 3. The dental chair 300 may be similar to a conventional dental chair and may include a moveable base 350, a back support 355, a head rest 360, one or more arm rests 365 and one or more seat and leg supports 370. One or more massage systems may be incorporated with the back support 355. For example, as illustrated in FIG. 3, the back support 355 can include four bladders 310a-310d. Bladders 310a and 310b may be positioned to cause movement in the shoulder portions of the back rest such that the shoulders of a patient seated in the dental chair 300 can be massaged by inflation and deflation of bladders 310a and 310b. Bladders 310c and 310d may be positioned to cause movement in the lumbar support region of the back rest 355. Inflation and deflation of bladders 310c and 310d thereby causes motions which may massage the lumbar region of a patient seated in the dental chair 300.

Bladders 310e and 310f positioned in the seat portion of the seat and leg support 370 may be inflated and deflated to cause motion in the seat portion of the dental chair 300. A patient seated in the dental chair 300 during the inflation and deflation of bladders 310e and 310f may have their seat area massaged by the motion caused by such inflation and deflation.

Bladders 310g and 310h may be positioned in a leg portion of the seat and leg support 370 such that the hamstring area of a patient seated in the dental chair 300 may be massaged by the inflation and deflation of the bladders 310g and 310h. Similarly, the calf muscle area of a patient seated in the dental chair 300 may be massaged by movement of a portion of the seat and leg support 370 caused by the inflation and deflation of bladders 310i and 310j.

Massage systems can also be incorporated into the arm rests 365 of a dental chair 300 as illustrated in FIG. 3. The bladders 310k and 3101 incorporated into the arm rests 365 illustrated in FIG. 3 may include single bladders or double bladders.

According to particular embodiments of the invention, one or more of the bladder pairs illustrated in FIG. 3 may be incorporated with a dental chair 300. In other embodiments, single bladders may also be used to cause motion to particular portions of the dental chair 300 to massage particular areas of the body of a patient seated in the dental chair 300. In still other embodiments, two or more bladders may be positioned next to each other, overlapping each other, or in another proximal position to create a desired massaging motion in a particular portion of a dental chair 300.

According to other embodiments of the invention, one or more massage systems may be retrofitted into a chair or a dental chair. For example, one or more of the bladders or massage systems illustrated in FIG. 3 may be incorporated into a conventional dental chair to provide massaging motions to a portion of the dental chair. The retrofitting of a conventional dental chair may be accomplished by removing a portion of the dental chair, such as the back support portion, and disassembling that portion to position a massage system in the portion of the dental chair. For example, if a back support portion of a dental chair is removed, a back plate of the back support may be separated from the back support material and foam, springs, and other materials held to the back plate by the back support material. The bladders of the massage system may be mounted to the interior of the back plate of the back support and the back support material, foam, springs, and other materials may be reattached to the back plate such that the bladders are contained in the back support. Delivery lines connected to the bladders may extend out of the back support and may be connected to a supply source for supplying fluid or gas to the bladders. In many dental chairs, the fluid supply source may be an air source integrated with the dental chair. The back support with bladders may be reattached to the dental chair and the supply source activated such that the massage system provides massaging motions to the back support.

According to some particular embodiments of the invention, each of the massage systems incorporated with an apparatus, such as a dental chair, or each of the bladders, bladder pairs, or plurality of bladders, may be individually turned on or off. In some embodiments, the amount of pressure supplied to the massage systems, bladders, bladder pairs, or plurality of bladders by a fluid or gas may be controlled, individually or as a group, to provide different levels of massage motion to the apparatus. The controls for the massage systems, bladders, bladder pairs, or plurality of bladders may be operated by a patient positioned in a dental chair, by a dentist or dental assistant, or by a computerized control system. The controls may be wired into a massage system or may be wireless controls, radio frequency controls, or other type of control allowing remote operation of the massage system.

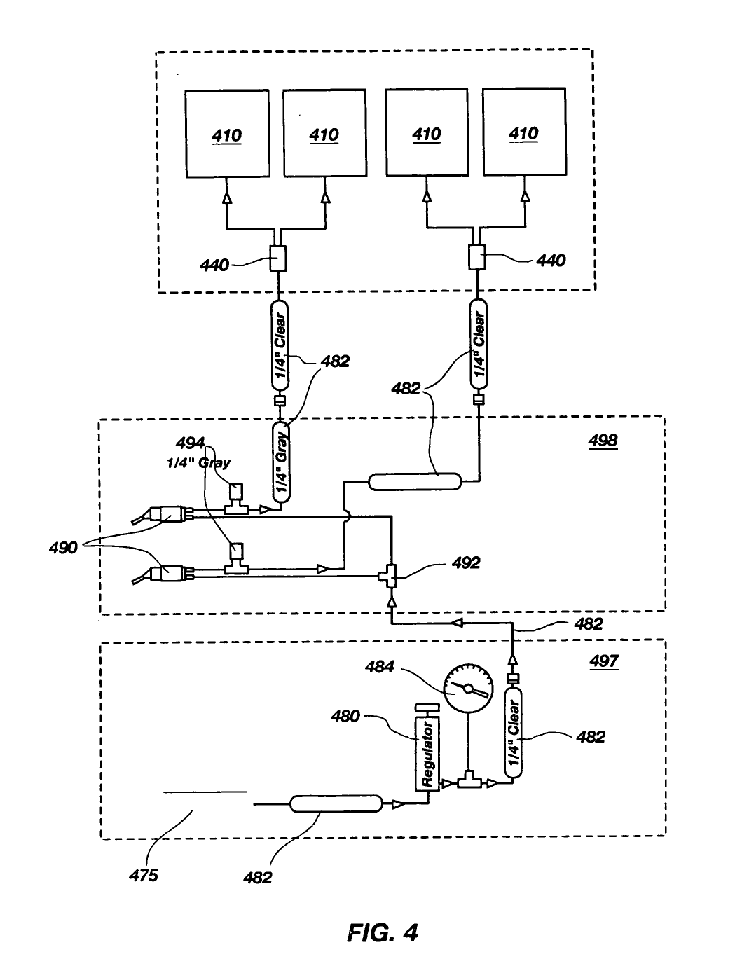

A schematic diagram of a massage system according to a particular embodiment of the invention is illustrated in FIG. 4. An air supply source 475 serving a dental chair may feed air to a regulator 480 through a tube 482. The tube may include any tubing or piping conventionally used with air supply lines in dental environments, such as, for example, quarter-inch diameter clear plastic or polymer tubing. The regulator 480 may decrease and limit the pressure of the air supplied to the massage system from the air supply source 475. In many conventional dental practices, the air from an air supply source 475 is provided at between about 80 and about 100 psi. The massage systems according to embodiments of the invention may operate at lower pressures, for example, between about 5 to about 10 psi. The regulator 480 may be used to limit the air pressure delivered from the air supply source 475 to the massage system to a desired pressure or pressure range.

The regulator 480 may also include a regulator gauge 484 for monitoring the pressure of air delivered to the massage system by the air supply source 475. A control valve (not shown) may be coupled with the regulator 480 and regulator gauge 484 to allow the air pressure delivered to the massage system by the air supply source 475 to be adjusted as desired.

Regulated air from the regulator 480 may be communicated through conventional tubing 482 to one or more switches 490 controlling the introduction of air to one or more bladders 410. If more than one switch 490 is being used with the massage system to allow multiple portions of the massage system to be turned on or off, an air flow splitter 492 may be placed in the air flow tubing 482 to split air flows to the desired switches 490. Each switch 490 may include an “on” and an “off” position. When in an “on” position, the switch 490 may allow air to flow through the switch to one or more bladders 410. In an “off” position, the switch 490 may stop the air flow to one or more bladders 410, thereby stopping a massaging motion caused by inflation and deflation of the bladders 410. The switches 490 may also be coupled with a relief valve 494 which will allow the release of air from tubing 482 communicating air to the bladders 410 should the pressure in the tubing 482 become too great for the massage system. The relief valves 494 may also allow the release of air when the switches 490 are in an “off” position, thereby allowing air in the bladders 410 to be released upon the switching “off” of a switch 490.

Air allowed to pass through switches 490, when the switches 490 are in an “on” position, passes to one or more valves 440 which may control the inflation and deflation of one or more bladders 410 associated with each valve 440. For instance, if two bladders 410 are associated with a single valve 440, a first bladder may be inflated while the second bladder may be deflated and vice versa. A massaging motion caused by the repetitive inflation and deflation of the bladders 410 may be transferred to a patient seated in a dental chair employing the massage system.

The regulator 480, regulator gauge 484, and optional control valve may be packaged in a single unit, such as a regulator bracket 497, such that an air supply source 475 may be attached to the regulator bracket 497 by conventional methods.

A switch box 498 holding one or more switches 490 may be coupled to the regulator bracket 497 or may include couplings for attaching the regulator bracket 497 or tubing 482 from the regulator bracket 497 to the switch box 498. The switch box 498 may also include outlet couplings for attaching tubing 482 from the switchbox 498 to one or more valves 440. Outlet couplings and couplings between a valve 440 and tubing 482 from a switchbox 498 may include conventional couplings.

The massage system illustrated in FIG. 4, or variations thereof, may be incorporated into a support apparatus, such as a dental chair. In addition, the massage system illustrated in FIG. 4 may be used to retrofit a conventional dental chair such that the conventional dental chair includes a massage system according to embodiments of the invention.

In some embodiments of the invention, the massage system illustrated in FIG. 4 may be retrofitted to a conventional dental chair by implanting the bladders 410 and valves 440 in one or more support structures of the dental chair. Tubing from the valves 440 may be run through the support structures and connected to a switchbox 498, which may be added to and attached to the dental chair or other support associated with the dental chair. The switchbox 498 may be coupled to a regulator bracket 497 which may also be added to or attached to the dental chair or other support associated with the dental chair. Once each piece of the massage system illustrated in FIG. 4 is attached to or otherwise associated with the dental chair, an air supply source 475 may be coupled to the regulator bracket 497 and the massage system activated.

Dental chairs incorporating massage systems according to particular embodiments of the invention may provide a method for targeting the pressure points of a patient's body or of varying the pressure points of a patient's body while positioned in a dental chair. For instance, a dental chair may include one or more massage systems according to embodiments of the invention, wherein the one or more massage systems provide massaging motions around a pressure point of a patient seated in the dental chair.

The massage systems according to embodiments of the invention may also stimulate blood flow in the body of a person in contact with the massage systems. For example, the blood flow in a patient positioned in a dental chair incorporating the massage systems according to embodiments of the invention may be stimulated or facilitated by the massaging action imparted on the patient's body by the massage system.

The massage systems according to embodiments of the invention may also lower the blood pressure of a patient in communication with the massage system. For instance, the blood pressure of a patient positioned in a dental chair equipped with a massaging system according to embodiments of the invention may be lowered with the application of the massaging action of the massage system to the patient's body. This may be especially true in those instances where a patient is anxious or has an elevated blood pressure due to the anxiety or nervousness generally associated with being a dental patient or the subject of examination by a medical professional.

The massage systems according to embodiments of the invention may also reduce the stress levels of a patient or other subject exposed to the massaging systems. As with the previous examples, a massage system incorporated with a dental chair may reduce the stress levels of a patient positioned in the dental chair due to the soothing nature of the massage received by the patient positioned in the dental chair from the massage system.

Although various embodiments of the invention have been described with particular detail to massage systems incorporated with dental chairs, it is understood that the massage systems of embodiments of the invention may be incorporated with other devices, and particularly with other chairs. For example, the massage systems according to embodiments of the invention may be incorporated with operatory chairs, examination chairs, or other seating devices or support surfaces of apparatuses and are not limited expressly to dental chairs.

Other embodiments of the present invention provide an apparatus for providing a massage to an individual supported by one or more support surfaces of the apparatus. One or more of such support surfaces may be adapted to cause an on-demand massage input to the portion of the individual that is in contact with the corresponding support surface. Typically, the apparatus is embodied as a chair that may be adjusted in both elevation and angle of repose for the supported individual. Certain embodiments structured according to the instant invention may be used to position a medical patient during a surgical or dental procedure. The invention may be used to particular advantage in a dental operatory to promote a relaxed feeling of well-being in a dental patient.

Chairs according to particular embodiments of the invention may provide a plurality of zones in which a patient may choose to receive a massaging input. The number and configuration of massage inputs provided by chairs structured according to the instant invention may be adjusted to suit a particular application or for individual taste.

Some particular embodiments provide massage capability to both lumbar and shoulder areas of a patient supported in the chair. It is within contemplation to also, or alternatively, include one or more massage elements in the seat portion of a chair, or in other areas, as desired. Furthermore, chairs structured according to principles of the invention may include additional segments, such as separate, or additional, leg supporting cushions. It is within contemplation that any such additional cushion elements may include one or more massage elements disposed to produce a massage input to a portion of the individual supported thereon.

In general, operable massage elements include any mechanism that can output a vibration or oscillation effective to cause a relaxing input to a chair's occupant or user. The vibrating mechanism can be powered by way of a utility, or input power source, that is readily available in the environment in which the chair is to be used. For example, in dental offices, air supplies and power supplies are generally available and built-in to each dental chair. It may also be generally desirable for the massage element to be relatively quiet during periods of its operation to promote relaxation of a user and to facilitate communication between attending personnel.

In alternative embodiments of the invention, it is within contemplation for an applied air stream to cause a vibrational output by being harnessed to rotate a weight mounted eccentrically about an axis. Alternative vibrating mechanisms may include one or more linkage systems arranged to produce a desired oscillating output responsive to an applied input. It is also understood that oscillating mechanisms may alternatively be driven by hydraulic or electric motors, or by using other applied inputs, such as solenoids, or systems incorporating magnetic or electrical attraction.

It may also be preferred to attach massage elements to a foundation, such as the substantially rigid backing component of the chair's back-rest cushion. One or more layers of foam of a desired thickness may then be applied over the massage element, such as one or more bladders, to help distribute the vibrational massage output of a massage element as an input to a desired target area of a person occupying the chair. A covering (such as cloth, plastic, naugahyde, leather, or the like) may then applied over the foam layer to create a support surface for the chair's occupant. In an operating environment, the chair's support surface desirably will be structured to facilitate cleaning off fluids that might be spilled onto, or otherwise come into contact with, the chair.

In addition, an apparatus control interface may be located at a convenient position for access by the chair's occupant. A control interface panel may be mounted at a fixed position to a structure associated with the chair, or may be mounted on some other convenient support surface. Alternatively, a portable or movable control panel may be provided to permit a user to adjust massage characteristics. One such portable control interface may include a control pad that may be tethered by a wire to the massage elements. An alternate portable interface may be formed by a portable control pad disposed in wireless communication with the massage elements. In any case, it is generally desirable for the chair's occupant to be able to select one or more areas to receive massage stimulation. Furthermore, in many cases, it is desirable for the user to be able to select and adjust massage characteristics, such as applied vibrational frequency and/or force.

Embodiments of the invention may be included in a chair as a factory-installed system. Alternatively, the invention may also be adapted to permit its retrofit into commercially available chairs, such as certain dental chairs. A kit may be provided, including one or more control panels, regulator, and controls (including valves) as required. When installing the retrofit massage components, care is taken by the field installer to avoid compromising functionality of both the chair and massage components.

Having thus described certain currently preferred embodiments of the present invention, it is understood that the invention defined by the appended claims is not to be limited by particular details set forth in the above description, as many apparent variations thereof are contemplated without departing from the spirit or scope thereof as hereinafter claimed.

1. A dental chair, comprising:
a back support;
a seat and leg support; and
at least one massage system incorporated with the back support.

2. The dental chair of claim 1, wherein the at least one massage system comprises:
at least one bladder;
at least one valve for regulating air flow to the bladder; and
at least one supply source for providing air to the at least one valve.

3. The dental chair of claim 1, further comprising at least one arm support.

4. The dental chair of claim 1, further comprising at least one head rest.

5. A kit for retrofitting a dental chair, comprising:
a regulator bracket;
a switch box; and
at least one valve and bladder combination.

6. The kit of claim 5, wherein the regulator bracket further comprises:
an air supply coupling;
a regulator coupled to the air supply coupling;
a regulator gauge for measuring the air pressure regulated by the regulator; and
a control valve for adjusting the air pressure regulated by the regulator.

7. The kit of claim 5, wherein the switch box further comprises:
an air inlet coupling;
at least one switch coupled to the air inlet coupling;
an air outlet coupling; and
a coupling connecting the at least one switch to the air outlet coupling.

8. The kit of claim 5, wherein the at least one valve and bladder combination further comprises:
at least one air inlet coupling;
at least one valve connected to the air inlet coupling; and
at least one bladder connected to the at least one valve.

9. A method of massaging a patient in a dental chair, comprising:
providing a dental chair;
providing at least one bladder in the dental chair;
providing at least one supply source for inflating and deflating the at least one bladder; and
inflating and deflating the at least one bladder in the dental chair.

10. The method of claim 9, wherein providing at least one bladder in the dental chair comprises providing at least one bladder for massaging the shoulders of a patient positioned in the dental chair.

11. The method of claim 9, wherein providing at least one bladder in the dental chair comprises providing at least one bladder for massaging the lumbar region of a patient positioned in the dental chair.

12. The method of claim 9, wherein providing at least one bladder in the dental chair comprises providing at least one bladder for massaging the seat of a patient positioned in the dental chair.

13. The method of claim 9, wherein providing at least one bladder in the dental chair comprises providing at least one bladder for massaging at least one leg of a patient positioned in the dental chair.

14. The method of claim 9, further comprising providing a control system for controlling the inflating and deflating of the at least one bladder in the dental chair.

15. A dental chair, comprising:
a back support;
a seat and leg support;
at least one massage system incorporated with the back support;
at least one valve for regulating air flow to the massage system; and
at least one supply source for providing air to the at least one valve.

16. The dental chair of claim 15, wherein the massage system comprises at least one bladder.
